(19) United States
(12) Patent Application Publication
(10) Pub. No.: US 2012/0161542 A1
(43) Pub. Date: Jun. 28, 2012

(54) METHOD AND SYSTEM FOR REDUCING RADIATION FIELD IN WIRELESS TRANSMISSION SYSTEM

(75) Inventors: Seong-Min KIM, Daejeon (KR); In-Kui Cho, Daejeon (KR); Je-Hoon Yun, Daejeon (KR); Jung-Ick Moon, Daejeon (KR); Seung-Youl Kang, Daejeon (KR); Yong-Hae Kim, Daejeon (KR); Sang-Hoon Cheon, Daejeon (KR); Myung-Lae Lee, Daejeon (KR); Woo-Jin Byun, Daejeon (KR); Chang-Joo Kim, Daejeon (KR)

(73) Assignee: ELECTRONICS AND TELECOMMUNICATIONS RESEARCH INSTITUTE, Daejeon (KR)

(21) Appl. No.: 13/335,915

(22) Filed: Dec. 22, 2011

(30) Foreign Application Priority Data
Dec. 23, 2010 (KR) 10-2010-0134010

(51) Int. Cl. H02J 17/00

(52) U.S. Cl. 307/104

(57) ABSTRACT

A system for reducing a radiation field in a wireless power transmission system includes a signal generation unit, a power amplification unit, a signal detection unit, a standing wave ratio (SWR) calculation unit and a control unit. The signal generation unit receives power and generates a signal for wireless power transmission. The power amplification unit amplifies the wireless signal generated by the signal generation unit. The signal detection unit detects a radiation signal generated by the magnetic resonator with respect to output power of the power amplification unit. The SWR calculation unit calculates an SWR using the detected radiation signal. The control unit selects a frequency having a lowest SWR based on the SWR calculated by the SWR calculation unit, and controls the signal generation unit to generate the signal for the wireless power transmission using the selected frequency.

### CROSS-REFERENCE TO RELATED APPLICATIONS

The present application claims priority of Korean Patent Application No. 10-2010-0134010, field on Dec. 23, 2010, which is incorporated herein by reference in its entirety.

### BACKGROUND OF THE INVENTION

1. Field of the Invention

Exemplary embodiments of the present invention relate to a method and system for reducing a radiation field in a wireless transmission system; and, more particularly, to a method and system for minimizing a radiation field that is generated around a magnetic resonator and may be an interference source influencing on an adjacent system or human body in a wireless power transmission system using magnetic resonance.

2. Description of Related Art

In 2007, MIT proposed a system for transmitting wireless power through magnetic resonance using two magnetic resonators having a same frequency. That is, the wireless power transmission system proposed by the MIT will be described. The wireless power transmission system uses two magnetic resonators with a helical structure, and the resonance frequency between the resonators is 10 MHz. In the size of the resonator with the helical structure, the diameter of the resonator is 600 mm, the helix of the resonator is 5.25 turns, the line thickness (diameter) of the resonator is 6 mm, the total thickness of the helical structure is 200 mm, and the length of a single loop for feeding signals is 250 mm. In such a resonance structure, a radiation field of about −11 dBi is generated, and strong electric fields exist together with magnetic fields between the resonators.

FIGS. 1a and 1b illustrates a shape of a conventional helical structure and an antenna gain for a radiation field generated in the helical structure.

A wireless power transmission system with the helical structure has a structure in which electric and magnetic fields exist around two resonators, and power is transmitted through the magnetic fields by the coupling between the two resonators. The electric and magnetic fields existing between the two resonators reach a level which has influence on a human body. Further, radiation fields radiated from the resonators cannot be negligible. Particularly, the radiation fields exist to the extent that causes a serious interference problem when high power is transmitted. For example, when power of 1 W, i.e., 30 dBm, is transmitted, the radiation field is 20 dBm, and power of 0.1 W is radiated in the air. The helical structure is a structure in which power of 10 W is radiated in the air when power of 100 W is transmitted. The helical structure is a structure that cannot be applied to the wireless power transmission system. When measuring electric fields around the helical structure, there exists an electric field of a few tens of V/m, which is considerably large.

### SUMMARY OF THE INVENTION

An embodiment of the present invention is directed to a method and system for reducing a radiation field in a wireless power transmission system, in which a resonator with a spiral structure is configured on a plane as compared with the conventional helical structure, thereby improving space efficiency.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a system for reducing a radiation field in a wireless power transmission system includes a signal generation unit configured to receive power and generate a signal for wireless power transmission; a power amplification unit configured to amplify the wireless signal generated by the signal generation unit; a signal detection unit configured to detect a radiation signal generated by the magnetic resonator with respect to output power of the power amplification unit; a standing wave ratio (SWR) calculation unit configured to calculate an SWR using the detected radiation signal; and a control unit configured to select a frequency having a lowest SWR based on the SWR calculated by the SWR calculation unit, and control the signal generation unit to generate the signal for the wireless power transmission using the selected frequency.

The control unit may control the signal generation unit to generate a signal by varying a frequency at a predetermined interval within a frequency variation range of the signal generation unit, store the SWR for each frequency, calculated by the SWR calculation unit, and then control the signal generation unit by selecting the frequency having the lowest SWR.

The magnetic resonator may include a resonator with a spiral structure.

In accordance with another embodiment of the present invention, a method for reducing a radiation field in a wireless power transmission system includes generating a signal of a frequency for wireless energy transmission by varying a frequency at a predetermined interval within a frequency variation range of a signal generation unit; detecting a radiation signal with respect to the signal of the frequency, generated in the generating of the signal of the frequency, and calculating an SWR for each frequency using the detected radiation signal; and selecting a frequency having a lowest SWR based on the calculated SWR, and controlling the signal generation unit to generate the signal for the wireless power transmission using the selected frequency.

### BRIEF DESCRIPTION OF THE DRAWINGS

FIGS. 1a and 1b illustrates a shape of a conventional helical structure and an antenna gain for a radiation field generated in the helical structure.

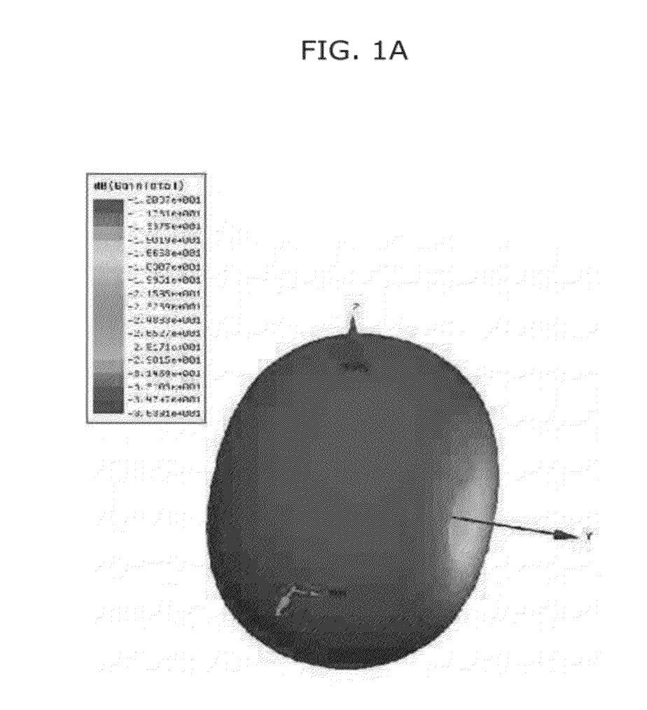

FIGS. 2A and 2B are a configuration diagram illustrating an embodiment of a resonator formed into a spiral structure applied to the present invention.

FIG. 3 is a graph illustrating signal reflection and transmission characteristics in the resonator with the spiral structure, used in the present invention.

FIG. 4 is a graph illustrating an electric field characteristic at a frequency of point A, which is a signal reflection characteristic.

FIG. 5 is a graph illustrating an electric field characteristic at a frequency of point B, which is a signal reflection characteristic.

FIG. 6 is a graph illustrating a magnetic field characteristic at the frequency of the point A, which is a signal reflection characteristic.

FIG. 7 is a graph illustrating a magnetic field characteristic at the frequency of the point B, which is a signal reflection characteristic.

FIG. 8 is a graph illustrating radiation efficiency at the frequency of the point A, which is a signal reflection characteristic.

FIG. 9 is a graph illustrating radiation efficiency at the frequency of the point B, which is a signal reflection characteristic.

FIG. 10 is a block configuration diagram of a system for reducing a radiation field in a wireless power transmission system in accordance with an embodiment of the present invention.

FIG. 11 is a flowchart illustrating a method for reducing a radiation field in the power transmission system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In the following description, a resonator provided with a spiral structure will be illustrated as an example, and it will be obvious by those skilled in the art that the present invention may be applied to resonators with any structure including a helical structure.

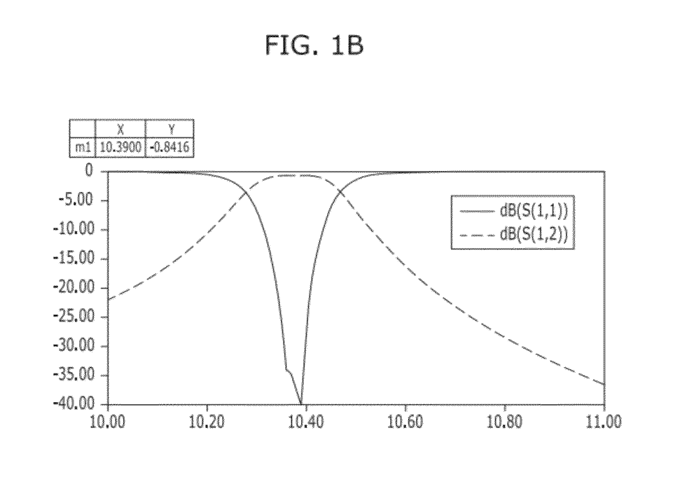

FIGS. 2A and 2B illustrate a resonator formed into a spiral structure applied to the present invention. The resonator includes a power-transmitting resonator 10 and a power-receiving resonator 20.

The power-transmitting resonator 10 and the power-receiving resonator 20 are positioned in insides of loop lines 12 and 22 for power supply, respectively. The loop lines 12 and 22 are provided with a power-transmitting point 13 and a power-receiving point 23, respectively.

Electric and magnetic fields exist around the power-transmitting resonator 10 and the power-receiving resonator 20, and power is transmitted by the coupling between the power-transmitting resonator 10 and the power-receiving resonator 20. The power-transmitting resonator 10 and the power-receiving resonator 20 are spaced apart from each other at a distance so as to ensure transmission efficiency having a predetermined value or more in wireless power transmission.

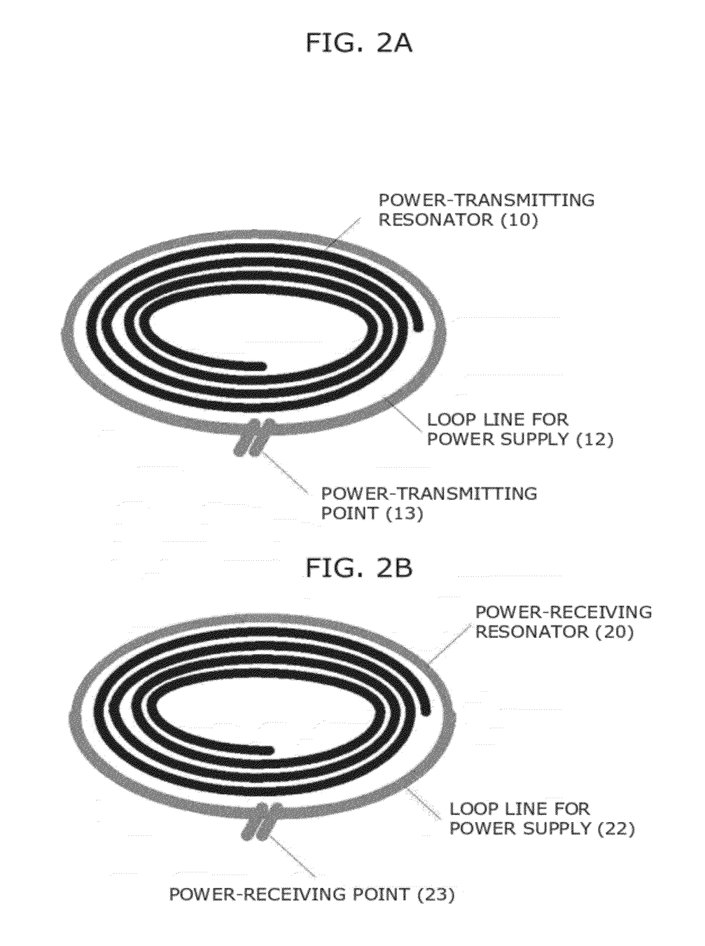

Hereinafter, characteristics of the resonator with the spiral structure applied to the present invention will be described with reference to FIGS. 3 to 9.

FIG. 3 is a graph illustrating signal reflection and transmission characteristics in the resonator with the spiral structure, used in the present invention.

In FIG. 3, the x-axis represents a frequency, and the y-axis represents transmission efficiency.

FIG. 3 illustrates a signal reflection characteristic S11 and a signal transmission characteristic S21, that occur in the wireless power transmission through the structure of the power-transmitting resonator 10 and the power-receiving resonator 20.

As illustrated in FIG. 3, signal reflection characteristics at two minimum points A and B are separately shown in the graph representing the signal reflection characteristic S11. This is because two individual resonators such as the power-transmitting resonator 10 and the power-receiving resonator 20 are used in the wireless power transmission. The signal reflection characteristics at the minimum points A and B are necessarily shown when the distance between the power-transmitting resonator 10 and the power-receiving resonator is within two times of the diameter of each of the resonators. This means a distance between two resonators (a power-transmitting resonator and a power-receiving resonator) for ensuring transmission efficiency having a predetermined value or more in the wireless power transmission.

A system for reducing a radiation field in a wireless power transmission system in accordance with the present invention is proposed using the signal reflection characteristics at the two minimum points A and B as illustrated in FIG. 3.

In FIG. 3, the signal transmission characteristics S21 at the minimum points A and B are hardly different from each other. Therefore, although power is transmitted by selecting the frequency at any one of the two points, the difference in the signal transmission characteristic S21 between the two points is not large, and thus the difference in wireless power transmission efficiency between the two points is not large. However, signal radiation characteristics at the frequencies respectively corresponding to the two minimum points A and B are considerably different from each other. The system is configured using the signal radiation characteristic described above, so that it is possible to reduce a radiation field in the wireless power transmission system, thereby minimizing interference between devices and influence on a human body.

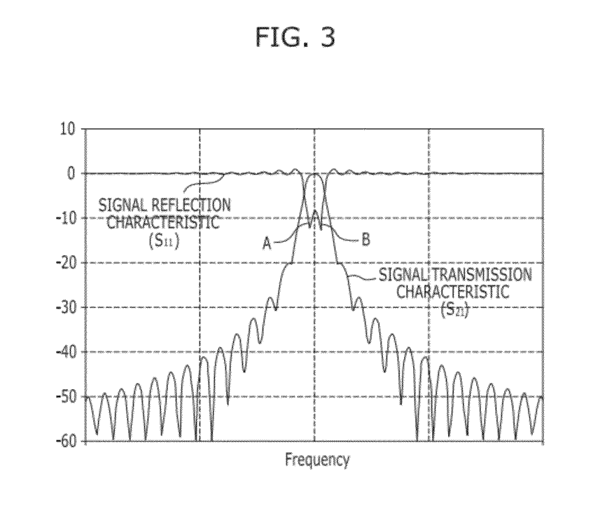

FIG. 4 illustrates an electric field characteristic on a vertical section around the resonators at a frequency of the point A of FIG. 3, i.e., at a low frequency.

As illustrated in FIG. 4, the amplitude of the electric field between the power-transmitting resonator and the power-receiving resonator is 84.5V/m.

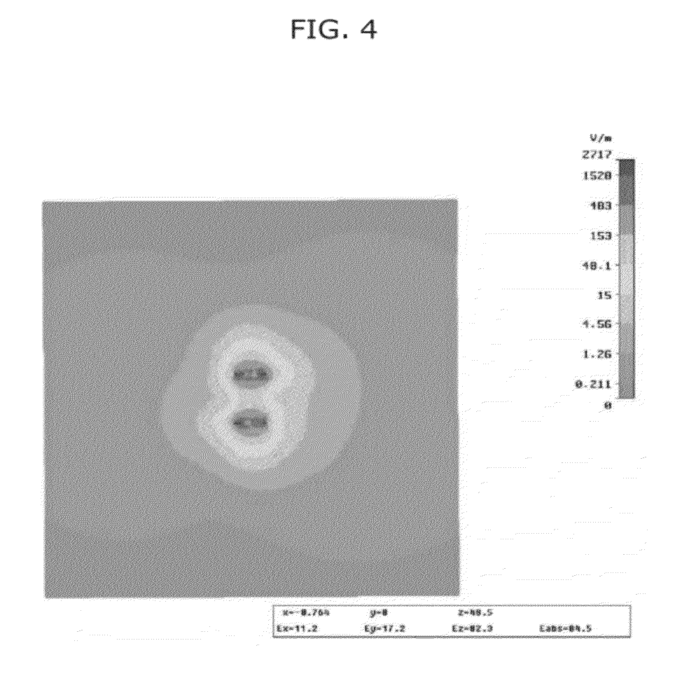

FIG. 5 illustrates an electric field characteristic on the vertical section around the resonators at a frequency of the point B of FIG. 3, i.e., at a high frequency. As illustrated in FIG. 5, the amplitude of the electric field between the power-transmitting resonator and the power-receiving resonator is 33.8V/m.

As illustrated in FIGS. 3 to 5, the difference in transmission efficiency between the frequencies at the two minimum points A and B is not large, but the difference in electric field distribution around the resonators at the two frequencies, particularly, between the power-transmitting resonator and the power-receiving resonator is two times or more. This means that although the same transmission efficiency is shown at the two minimum points A and B, the electric field radiated around the resonators at the high frequency of the minimum point B is smaller than that at the low frequency of the minimum point A.

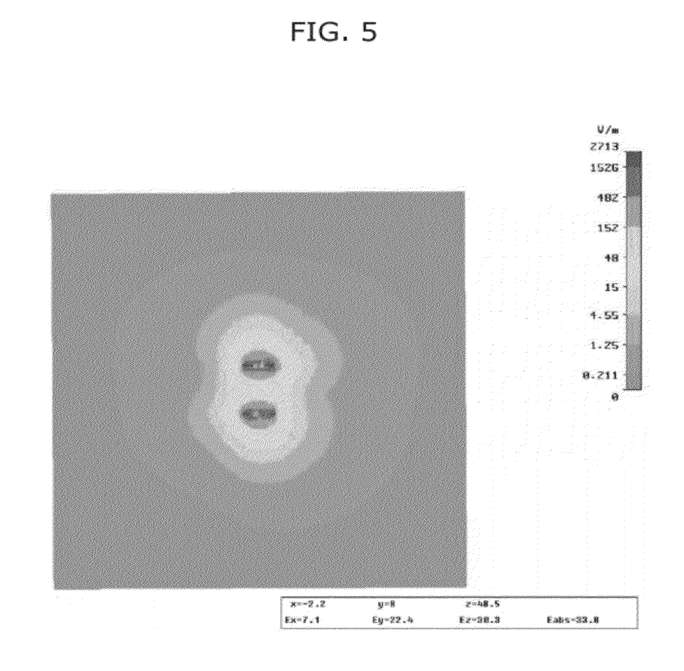

FIG. 6 illustrates a magnetic field characteristic on the vertical section around the resonators at the frequency of the point A of FIG. 3, i.e., at the low frequency. As illustrated in FIG. 6, the amplitude of the magnetic field between the power-transmitting resonator and the power-receiving resonator is 0.476 A/m.

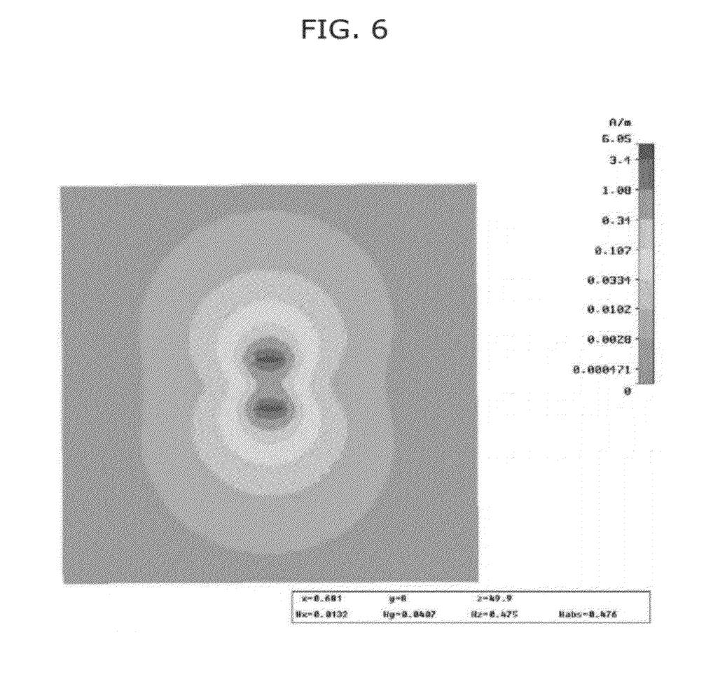

FIG. 7 illustrates a magnetic field characteristic on the vertical section around the resonators at the frequency of the point B of FIG. 3, i.e., at the high frequency.

As illustrated in FIG. 7, the amplitude of the magnetic field between the power-transmitting resonator and the power-receiving resonator is 1.62 A/m. As illustrated in FIGS. 3, 6 and 7, the difference in transmission efficiency between the frequencies at the two minimum points A and B is not large, but the difference in magnetic field distribution around the resonators at the two frequencies, particularly, between the power-transmitting resonator and the power-receiving resonator is about three times. This means that although the same transmission efficiency is shown at the two minimum points A and B, the magnetic field radiated around the resonators at the high frequency of the minimum point B is smaller than that at the low frequency of the minimum point A.

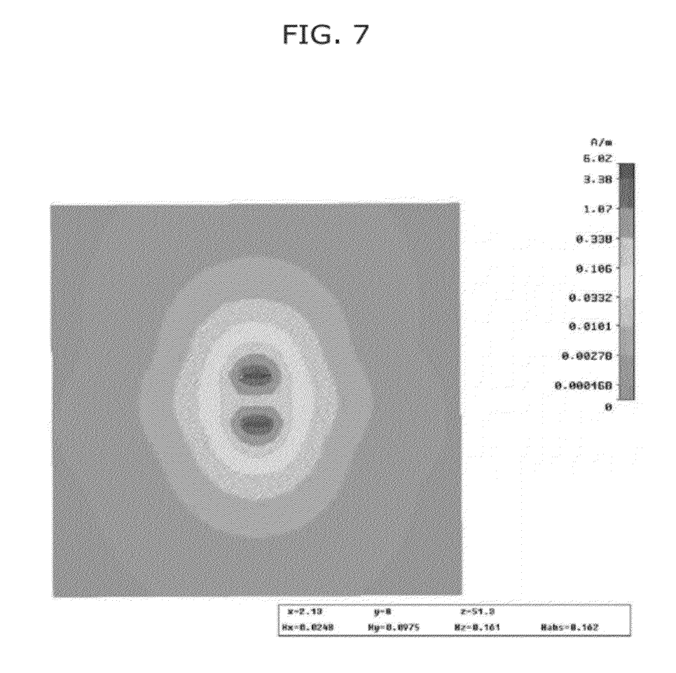

FIG. 8 illustrates radiation efficiency around the resonators at the frequency of the point A of FIG. 3, i.e., the low frequency.

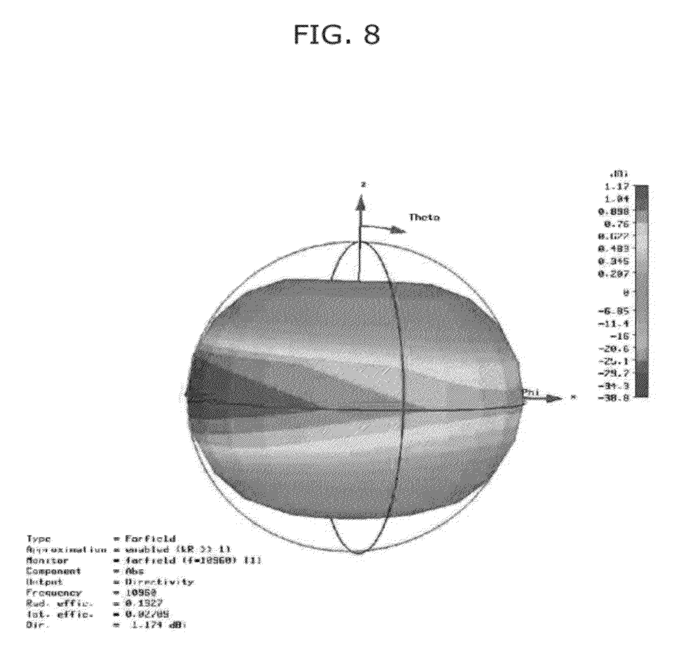

Referring to FIG. 8, the radiation efficiency at the low frequency of the point A is 0.1327. The radiation efficiency is compared with that around the resonators at the high frequency of the point B illustrated in FIG. 9.

FIG. 9 illustrates radiation efficiency around the resonators at the frequency of the point B of FIG. 3, i.e., the high frequency. The radiation efficiency at the high frequency of the point B is 0.0186. The radiation efficiency is about 10% of that at the low frequency of FIG. 8. Accordingly, it is possible to reduce about ten times of the radiation field at the low frequency of FIG. 8.

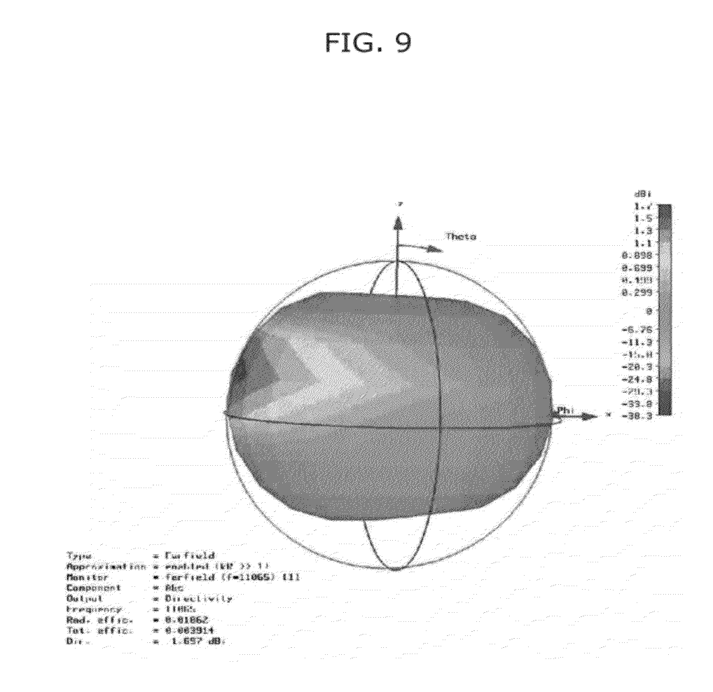

FIG. 10 is a block configuration diagram of a system for reducing a radiation field in a wireless power transmission system in accordance with an embodiment of the present invention.

The system is a system for generating a frequency signal used in wireless power transmission from commercial AC power, amplifying or converting the generated frequency signal into a signal having a desired power level and then transmitting the amplified or converted signal to a resonator.

The system illustrated in FIG. 10 is merely one embodiment, and may be configured in various forms capable of obtaining effects of the present invention through signal detection and standing wave ratio (SWR) detection.

Referring to 10, the system 100 includes a signal generation unit 102, a power amplification unit 104, a signal detection unit 106, an SWR calculation unit 108 and a control unit 110. The signal generation unit 102 generates a signal of a frequency used in wireless power transmission by receiving general commercial AC power. The power amplification unit 104 amplifies the frequency signal generated by the signal generation unit 102. The signal detection unit 106 transmits the signal amplified by the power amplification unit 104 to a magnetic resonator for the wireless power transmission, and detects a radiation signal generated by the magnetic resonator. The SWR calculation unit 108 calculates an SWR from the signal detected by the signal detection unit 106. The control unit 110 selects a frequency having a lowest SWR using the SWR calculated by the SWR calculation unit 108, and controls the signal generation unit 102 to generate the signal for the wireless power transmission power using the selected frequency.

A detailed operation of the system configured as described above according to the present invention will be described with reference to FIG. 10.

The signal generation unit 102 receives general commercial AC power and generates a signal of a frequency used in wireless power transmission. Then, the signal generation unit 102 transmits the generated signal to the power amplification unit 104. In this case, the signal generation unit 102 generates a signal for the wireless power transmission using a frequency having a lowest SWR under a control of the control unit 110.

The power amplification unit 104 amplifies the wireless signal inputted from the signal generation unit 102 to a signal having a power level required by the system, and outputs the amplified signal.

The signal detection unit 106 transmits the signal amplified by the power amplification unit 104 to a magnetic resonator for the wireless power transmission, and detects a radiation signal generated by the magnetic resonator. Then, the signal detection unit 106 transmits the detected radiation signal to the SWR calculation unit 108.

The SWR calculation unit 108 calculates an SWR representing the amplitude of the radiation signal with respect to output power of the power amplification unit 104 using the radiation signal inputted from the signal detection unit 106, and transmits the calculated SWR to the control unit 110.

The control unit 110 controls the frequency of the signal generated by the signal generation unit 102 using the SWR inputted from the SWR calculation unit 108. That is, the control unit 110 determines a frequency having a lowest SWR using the SWR calculated by the SWR calculation unit 108, and controls the signal generation unit 102 to be operated at the determined frequency.

That is, if the power of the system is turned on, the control unit 110 controls the signal generation unit 102 to generate the signal by varying the frequency at a predetermined interval within a frequency variation range of the signal generation unit 102 so as to improve transmission efficiency and determine the presence of impedance matching with the magnetic resonator. Accordingly, the SWR calculation unit 108 calculates an SWR for each frequency using the radiation signal for each frequency, detected by the signal detection unit 106. The SWR for each frequency, calculated by the SWR calculation unit 108, is stored in a storage medium of the control unit 110. The control unit 110 performs an operating logic for selecting a frequency having maximum transmission efficiency, i.e., a lowest SWR, using the SWR for each frequency, stored in the storage medium. The control unit 110 controls the signal generation unit 102 so as to transmit wireless power using the selected frequency.

Although it has been illustrated in the embodiment of the present invention that the SWR calculation unit 108 and the control unit 110 are separately configured, the SWR calculation unit 108 and the control unit 110 may be implemented in one processor. Although it has been illustrated in the embodiment of the present invention that the signal detection unit 106 and the SWR calculation unit 108 are separately configured, the signal detection unit 106 and the SWR calculation unit 108 may be implemented in one device.

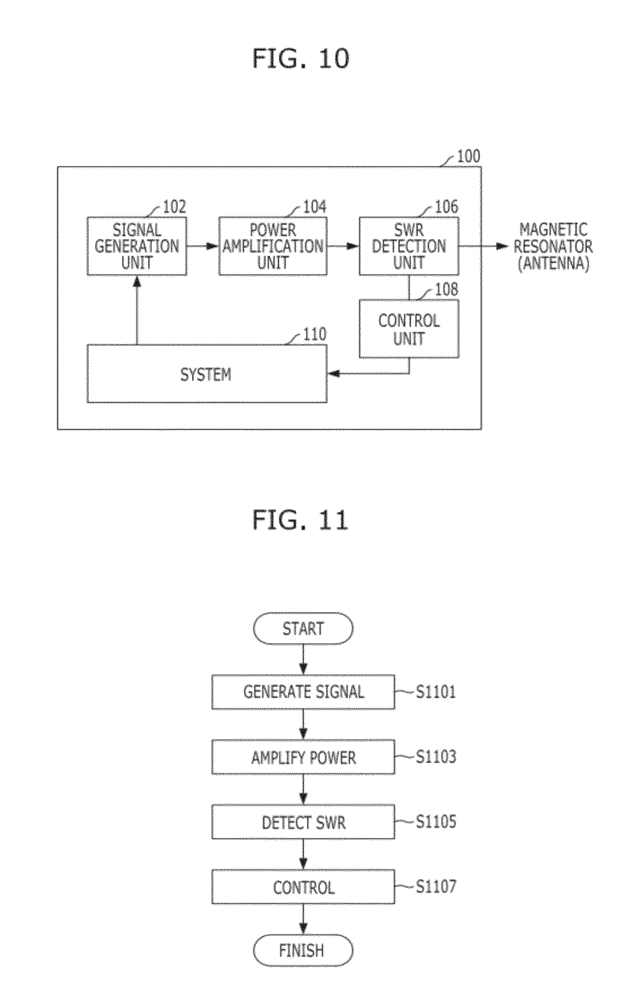

FIG. 11 is a flowchart illustrating a method for reducing a radiation field in the power transmission system in accordance with an embodiment of the present invention.

If the power of the system is turned on, a signal of a frequency for wireless power transmission is generated by varying the frequency at a predetermined interval within a frequency variation range so as to improve transmission efficiency and determine the presence of impedance matching with a magnetic resonator (1101).

Then, a radiation signal is detected from each frequency generated by varying the frequency, and an SWR for each frequency is calculated using the detected radiation signal (1102). The calculated SWR for each frequency is stored in a storage medium (1103). An operating logic of the control unit is performed to select a frequency having maximum transmission efficiency, i.e., a lowest SWR, using the SWR for each frequency, stored in the storage medium (1104). The control unit performs a control so as to transmit wireless power using the frequency having the selected lowest SWR (1105).

In accordance with the exemplary embodiments of the present invention, wireless power is transmitted by measuring an SWR at an output terminal of the system and selecting a frequency having a low radiation field through the measured SWR. Accordingly, it is possible to improve transmission efficiency and minimize a radiation field that may be an interference source.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A system for reducing a radiation field in a wireless power transmission system, the system comprising:
a signal generation unit configured to receive power and generate a signal for wireless power transmission;
a power amplification unit configured to amplify the wireless signal generated by the signal generation unit;
a signal detection unit configured to detect a radiation signal generated by the magnetic resonator with respect to output power of the power amplification unit;
a standing wave ratio (SWR) calculation unit configured to calculate an SWR using the detected radiation signal; and
a control unit configured to select a frequency having a lowest SWR based on the SWR calculated by the SWR calculation unit, and control the signal generation unit to generate the signal for the wireless power transmission using the selected frequency.

2. The system of claim 1, wherein the control unit controls the signal generation unit to generate a signal by varying a frequency at a predetermined interval within a frequency variation range of the signal generation unit, stores the SWR for each frequency, calculated by the SWR calculation unit, and then controls the signal generation unit by selecting the frequency having the lowest SWR.

3. The system of claim 2, wherein the magnetic resonator comprises a resonator with a spiral structure.

4. A method for reducing a radiation field in a wireless power transmission system, the method comprising:
generating a signal of a frequency for wireless energy transmission by varying a frequency at a predetermined interval within a frequency variation range of a signal generation unit;
detecting a radiation signal with respect to the signal of the frequency, generated in the generating of the signal of the frequency, and calculating an SWR for each frequency using the detected radiation signal; and
selecting a frequency having a lowest SWR based on the calculated SWR, and controlling the signal generation unit to generate the signal for the wireless power transmission using the selected frequency.
